(19) United States
(12) Patent Application Publication
(10) Pub. No.: US 2010/0252697 A1
(43) Pub. Date: Oct. 7, 2010

(54) Hollow Profile and Telescoping Support

(76) Inventor: Martin Koenig, Niefern (DE)

Correspondence Address: SLATER & MATSIL, L.L.P., 17950 PRESTON RD, SUITE 1000, DALLAS, TX, 75252-5793, US

(21) Appl. No.: 12/663,912

(22) PCT Filed: Jun. 12, 2008
(86) PCT No.: PCT/EP08/57417

§ 371 Date: May 13, 2010

(30) Foreign Application Priority Data
Jun. 13, 2007 (DE) 102007027232.6

(51) Int. Cl. F16S 3/02

(52) U.S. Cl. 248/161

(57) ABSTRACT

The invention relates to a modularly constructed hollow profile, as well as a telescoping carrier, such as a lifting column, that is formed by the modularly constructed hollow profiles.

This patent application is a national phase filing under section 371 of PCT/EP2008/057417, filed Jun. 12, 2008, which claims the priority of German patent application 10 2007 027 232.6, filed Jun. 13, 2007, each of which is incorporated herein by reference in its entirety.

### TECHNICAL FIELD

Embodiments of the invention relate to a hollow profile as well as a telescoping support whose telescope stages are constructed from a hollow profile.

### BACKGROUND

Until now hollow profiles made either of aluminum or steel have been used for the supporting element in common designs of lifting columns. These are closed, single-part hollow profiles of various design types. It is fundamentally necessary for a new, different profile to be used for each telescope stage (of which there are generally two or three). Since these are hollow profiles, the installation of parts such as the motor or the controller for a lifting column inside these profiles can be accomplished only with great technical expense. In some cases, it is not reasonably possible to mount such parts inside the hollow profile at all.

### SUMMARY

Aspects of the invention provide an improved hollow profile as well as a telescoping support made of hollow profiles that largely avoids the above-mentioned disadvantages.

With respect to the hollow profile, an embodiment of the invention includes constructing the hollow profile of individual parts.

The multipart construction of the wall has the advantage that components such as the motor or the controller can be installed on the individual parts before the assembly, or in the semi-assembled state of the hollow profile, i.e., one side is still open and the interior of the hollow profile is thus still accessible.

The hollow profile is preferably constructed of several individual parts, including at least two individual profiles.

The individual profiles can comprise aluminum, steel, plastic and other suitable materials. In the composition, not all individual parts need be constructed from the same material; thus certain individual parts can be manufactured from plastic, and the others from aluminum. By mixing materials, an optimal harmony with respect to stability, weight, and, not least, the design, can be achieved.

The individual parts are glued to one another according to a preferred embodiment.

Alternatively, the individual parts can also be positively connected to one another, the individual parts preferably being additionally glued to one another even in this embodiment.

According to one embodiment, the hollow profile is formed from four individual parts, with two identical parts in each case.

The use of identical parts in the construction of the hollow profile has the advantage that the tool costs can thereby be lowered by 50%.

With respect to the telescoping support with several telescope stages, one or all telescope stages of the carrier are formed by a hollow profile constructed from individual parts.

The telescoping support is preferably constructed as a lifting column for a height-adjustable table. Alternatively, the telescoping support can also be constructed as a telescoping rail.

In the construction of several telescope stages according to the hollow profile of the invention, it is favorable if, for the different telescope stages, two individual parts remain identical in each case, and only the other individual parts are constructed differently. With this measure as well, the tool costs can be drastically reduced, since a new tool for each individual part type is not necessary for each telescope stage, but instead, certain individual parts can be used for several telescope stages.

The telescope stages are preferably mutually guided by bearing elements. According to a preferred embodiment, the profiles each have a recess on both the inner and the outer side, into which lubricating elements are glued at defined intervals.

According to an alternative embodiment, the bearing elements are based on the tongue-and-groove principle, with lubricating elements also being inserted at defined intervals to improve the sliding properties in this embodiment as well.

The bearing elements according to the tongue-and-groove principle are advantageously designed in such a manner that the individual profiles are already connected to one another by the bearing elements.

The construction of a telescoping carrier with the hollow profiles constructed modularly out of individual parts has the advantage that it is possible to compensate for tolerances considerably more simply and precisely. In conventional hollow profiles made from aluminum, for example, this represents a large problem. Aluminum hollow profiles are generally produced by an extrusion process, wherein the aluminum represents a very abrasive material to the tool. This means that the shape or the dimensions of the hollow profile change continuously over the service life of the tool. In addition, it is extremely difficult, depending on the length of the hollow profile, to position the lubricating elements in the interior in a telescoping arrangement of the hollow profiles. By constructing a telescoping support from hollow profiles that are modularly constructed from individual parts, the tolerances can be compensated for by means of the subsequent assembly, and the insertion of the bearing elements or lubricating elements is substantially simpler on the open profile than on a closed profile. Thus, the modular construction of the hollow profiles allows not only a simpler assembly, but also the possibility of dramatically reducing the air gap between the telescope stages.

Additional advantageous implementations of the invention are disclosed below.

### BRIEF DESCRIPTION OF THE DRAWINGS

The invention will be described in detail below with reference to embodiments represented in the drawings.

FIG. 1 shows a modularly constructed hollow profile in an oblique view and an exploded representation;

FIG. 2 shows the hollow profile according to FIG. 1 in a view from above;

FIG. 3 shows the view of a hollow profile with only two individual parts from above;

FIG. 4 likewise shows the view of a hollow profile with only two individual parts in an alternative embodiment;

FIG. 5 shows a telescoping lifting column made of hollow profiles in accordance with FIGS. 1 and 2 in an oblique view;

FIG. 6 shows the telescoping lifting column according to FIG. 5 in a view from above;

FIG. 7 shows the detail A from FIG. 6 enlarged by a factor of five;

FIG. 8 shows a telescoping lifting column in an alternative embodiment in a view from above; and

FIG. 9 shows the detail A from FIG. 8 enlarged by a factor of five.

The following list of reference numbers can be used in conjunction with the drawings:
1, 1′, 1″ Individual part
2, 2′, 2″ Individual part
3 Individual part
4 Individual part
5 Joining sites
6 Groove
7 Tongue
8 Groove in the side wall
9 Tongue in the side wall
10 Receptacle
11 Drillhole
12 Recess, inside
13 Recess, outside
14 Slider
15 End part
16 Side part
17 Joining sites
18 Tongues
19 Grooves
20 Slider

### DETAILED DESCRIPTION OF ILLUSTRATIVE EMBODIMENTS

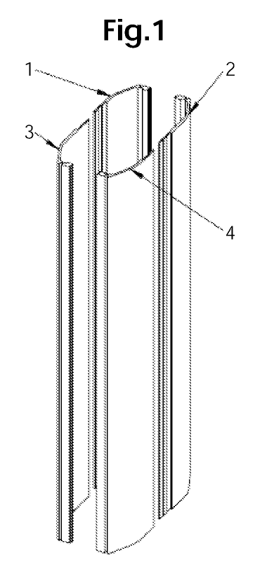

In an oblique exploded view, FIG. 1 shows a hollow profile that is constructed from four individual pieces 1-4. The individual pieces 1-4 each constitute the wall of the hollow profile and, in the assembled state, enclose the single cavity, directly surrounded by the wall, in the hollow profile.

Each of the individual components 1-4 is constructed as individual profiles formed of a variety of materials, such as aluminum, steel or plastic. When manufactured from plastic or aluminum, they can be produced in an extrusion process, just like the previously known hollow profiles.

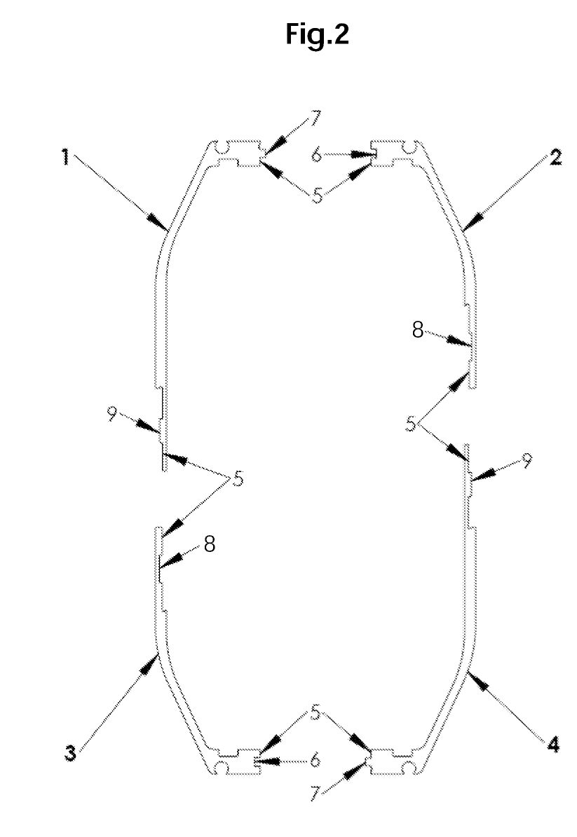

FIG. 2 shows the individual parts 1-4 in a view from above.

In the structure shown in FIGS. 1 and 2, the individual parts 1 and 4 are identical, as are 2 and 3, so that only two tools are required for production. Because of the modular construction, the individual components can be optimally designed for the intended use. For instance, one can choose to make certain individual parts from aluminum, and others from plastic or wood. The profile can thereby be optimized with respect to weight and stability. It is also easily possible to slightly modify the design of the hollow profile in such a way that different materials can be combined, for example, or only one side part can be provided with the product name or promotional printing.

The individual parts 1-4 are connected to one another at their joining sites 5. In the illustrated embodiment, the connection is performed as an adhesive connection. The adhesive connection has proven to be sound-damping when, for example, a motor is integrated into the hollow profile. In order to guarantee an exact mutual positioning of the individual parts, the joining sites are configured as tongue-and-groove joints both laterally and on the end surfaces. On the end surface, for example, a groove 6 is formed on individual part 2 and a corresponding tongue 7 is formed on individual part 1, as, correspondingly, for individual parts 3 and 4. For example, a groove 8 is formed on individual part 3 and a tongue 9 on individual part 1. During assembly, the tongue-and-groove joints are merely provided with glue and pressed together.

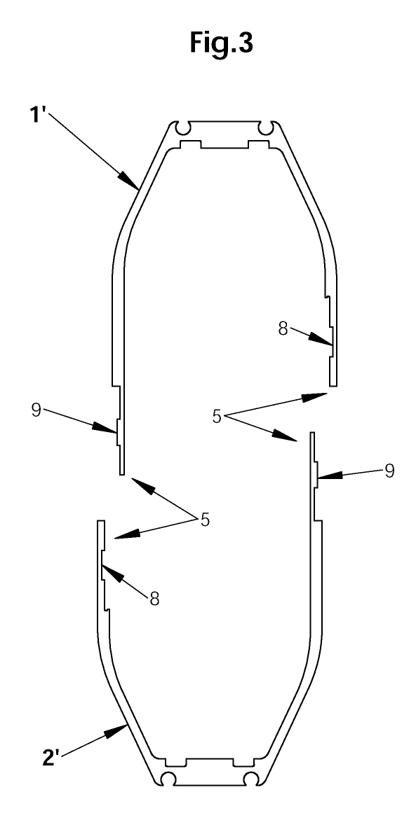

FIG. 3 shows an alternative embodiment of the modularly constructed hollow profile. In this embodiment, the hollow profile is formed from only two individual parts 1′ and 2′, which are connected only laterally via joining sites 5 and a tongue-and-groove joint with groove 8 and tongue 9. This embodiment has the advantage that two identical individual parts 1′ and 2′ can be used for constructing the hollow profile, and only two joining sites are necessary.

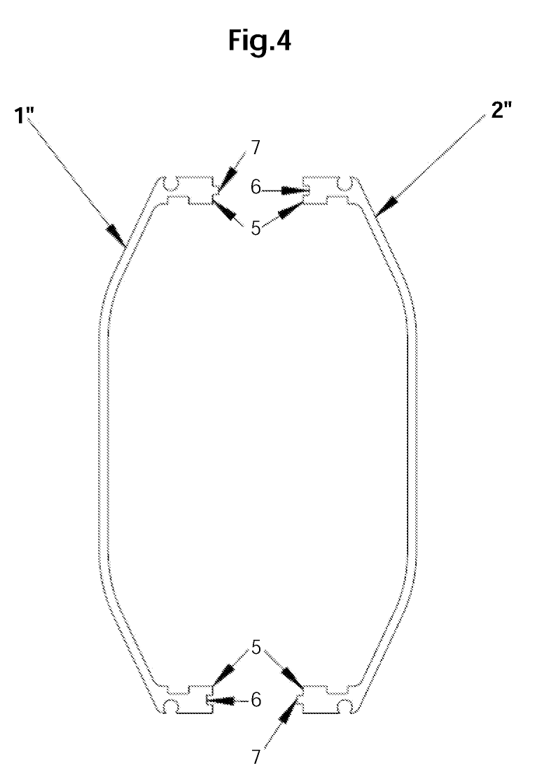

FIG. 4 shows an additional alternative embodiment for the construction of a modularly constructed hollow profile from only two individual parts 1″ and 2″, with the separation being maintained here by the end surfaces of the hollow profile.

The two individual parts 1″ and 2″ are joined via the joining sites 5, using the same tongue-and-groove joint with groove 6 and tongue 7 as that explained with respect to FIG. 2.

In this embodiment as well, two identical individual parts can be used for constructing the hollow profile.

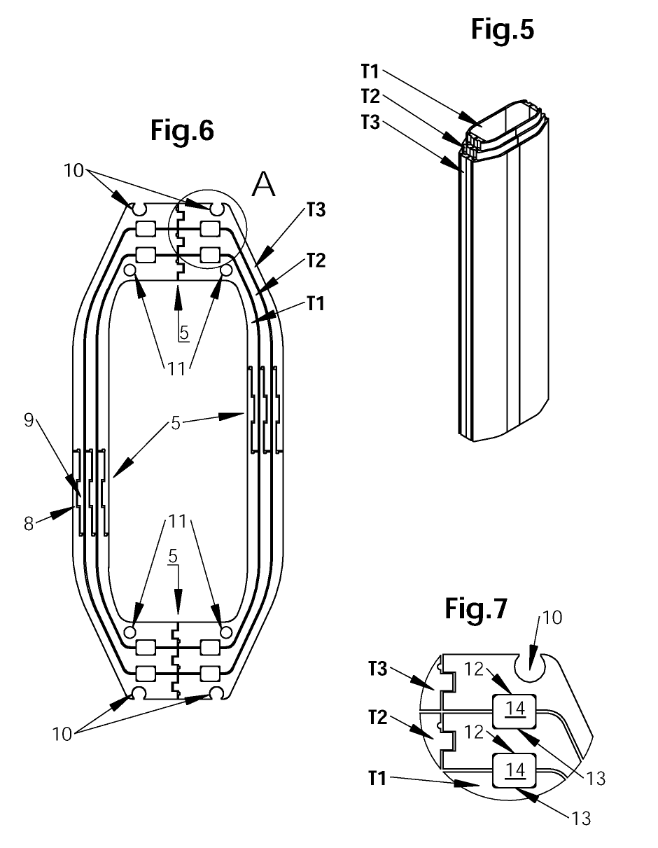

In an oblique view, FIG. 5 shows a telescoping carrier with three telescope stages T1-T3, constructed of a hollow profile as represented in FIGS. 1 and 2.

The illustrated telescoping carrier is generally used as a lifting column for height-adjustable tables, for example. Alternatively, other uses such as telescoping rails are possible.

FIG. 6 shows the telescoping profile according to FIG. 5 in a view from above. With respect to the characteristics explained for FIG. 2, the telescope stages T1-T3 correspond exactly to the structure illustrated in FIG. 2.

Receptacles 10 are provided only on the end surface of telescope stage T3. The receptacles 10 serve to accommodate accessory parts such as height-adjustable tables for a cantilever foot or a plate carrier. In the illustrated embodiment, drillholes 11, which serve for mounting telescope stage T1 on a base, are provided on the inner telescope stage T1.

In order to make telescope stages T1-T3 move smoothly relative to one another, they are guided by so-called bearing elements. The construction of the bearing elements will be explained below with reference to FIG. 7, which shows the detail A from FIG. 6 enlarged by a factor of five. The bearing elements according to this embodiment are formed by recesses 12 on the inside of the end surfaces of the individual parts and by directly opposing recesses 13 on the outside of the end surfaces of the individual parts. Between the two recesses 12 and 13, a so-called slider 14 is glued on one side in recess 12 or 13, so that telescope stage T1 is guided with respect to T2, and T2 with respect to T3 via the sliders 14 in each case.

Of course, recess 13 can be omitted on the outside of telescope stage T3, and recess 12 on the inside of telescope stage T1.

The construction of the hollow profile from four individual parts and the guidance via the bearing elements, formed in this case by means of the recesses 12, 13 and the sliders 14 arranged therebetween, has the advantage that the gap size between telescope stages T1 and T2, or T2 and T3, can be dramatically reduced, and lies in the range of 0.5 mm in this construction for a lifting column for a work table. Tolerance compensation is generally achieved by the modular construction and subsequent joining by gluing. As can be well recognized in FIG. 6 at the lateral joining sites 5, the tongue-and-groove joints with groove 8 and tongue 9 have a certain play laterally. The same applies to the joining sites on the end surface, as can be seen in part in enlarged form in FIG. 7. By the subsequent assembly and the insertion of the slider 14, it is therefore possible to compensate for manufacturing tolerances in the individual parts by means of the assembly.

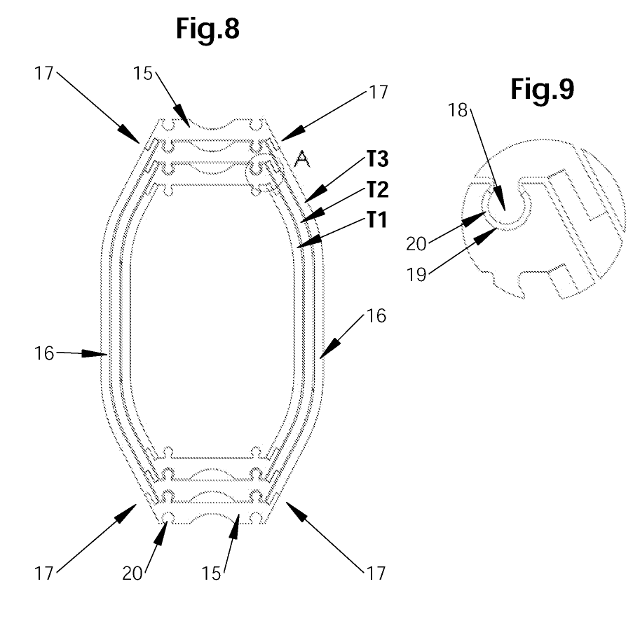

FIG. 8 likewise shows a telescoping carrier with three telescope stages T1-T3 in a view from above, as in FIG. 6. Here, however, the modularly constructed hollow profiles have a different structure. The construction is identical between telescope stages T1-T3, and its principle will be explained here with reference to telescope stage T3. A hollow profile in the embodiment according to FIG. 8 includes two identical individual parts in the form of end parts 15 as well as two identical parts in the form of side parts 16, which are glued at joining sites 17 to end parts 15. Just as in the previously described embodiments, end parts 15 as well as side parts 16 can be formed of different materials, such as aluminum, steel, plastic or wood, and the profile can be optimally matched to the intended use, i.e., assembled from different materials appropriately with regard to weight, appearance and stability.

Telescope stages T1-T3 are likewise mutually guided via bearing elements, the bearing elements being configured in the present embodiment according to the tongue-and-groove principle. FIG. 9 shows the detail A from FIG. 8 in an enlarged representation.

For the mutual bearing of telescope stages T1-T3, inwardly-projecting ridges or tongues 18 are formed on the end parts 15 that can be inserted or pushed into matching grooves 19 formed on the outside of the end parts 15. In the illustrated embodiment, the tongue-and-groove joint is in a form-fitting construction, i.e., tongue 18 can only be pushed into groove 19 from above, and cannot be pulled out laterally from groove 19.

In order to guarantee an optimal guidance between the telescope stages in this embodiment as well, a 1-3 cm-high slider 20 is either glued into or onto either tongue 18 or groove 19 at defined intervals. The amount of tolerance can likewise be subsequently optimized by the slider 20. The embodiment according to FIG. 8 has the advantage that the same end part 15 can be used for all telescope stages T1-T3. The outward-facing groove 19 on outer end part 15 of telescope stage T3 can also serve as a receptacle for accessory parts.

According to an embodiment that is not shown, the individual parts of the hollow profile are configured in such a manner that they can all be positively fixed to one another.

According to an advantageous refinement of the invention, not shown, two respective parts of the hollow profile, for example, the side parts 16 in FIG. 8, are formed from a conductive material, these two parts being electrically insulated from one another, for example, by forming the end parts 15 from plastic.

This offers the possibility of simultaneously using the telescoping rail for conducting direct current. Sliding contacts are advantageously provided between the telescope stage for contact between the individual telescope parts.

The invention is not limited to the embodiments illustrated or described above. In particular, all characteristics of the embodiments can also be combined into new embodiments.

1. A hollow profile comprising a plurality of individual parts, wherein a wall of the hollow profile is constructed of the individual parts.

2. The hollow profile according to claim 1, wherein the individual parts comprise at least two identical individual profiles.

3. The hollow profile according to claim 1, wherein the individual parts comprise aluminum, steel or plastic parts.

4. The hollow profile according to claim 1, wherein the individual parts are connected to one another by gluing.

5. The hollow profile according to claim 1, wherein the individual parts are positively connected to one another.

6. The hollow profile according to claim 1, wherein the hollow profile comprises first, second, third and fourth individual parts, the first part being identical to the second part.

7. A telescoping carrier comprising a plurality of telescope stages, wherein at least one of the telescope stages is formed by a hollow profile that comprises a plurality of individual parts, wherein a wall of the hollow profile is constructed of the individual parts.

8. The telescoping carrier according to claim 7, wherein another one of the telescope stages is formed by another hollow profile that comprises a plurality of individual parts, wherein a wall of the other hollow profile is constructed of the individual parts of the other hollow profile, the hollow profile and the other hollow profile each comprising first, second, third and fourth individual parts, two of the individual parts of the hollow profile and the other hollow profile being identical and two other parts of the hollow profile and the other hollow profile being different from each other.

9. The telescoping carrier according to claim 7, wherein the telescope stages are mutually guided by bearing elements.

10. The telescoping carrier according to claim 9, wherein the bearing elements comprise recesses in the individual parts and glued-in sliders.

11. The telescoping carrier according to claim 9, wherein the bearing elements are configured as a groove on an inside and a tongue on an outside of each individual part.

12. The telescoping carrier according to claim 11, wherein the bearing elements positively connect the telescope stages to one another.

13. The telescoping carrier according to claim 11, wherein the groove or the tongue is provided with a slider at certain intervals.

14. The telescoping carrier according to claim 11, wherein the bearing elements on the outside of an outermost telescope stage serve as a receptacle for accessory items.

15. The telescoping carrier according to claim 7, wherein the telescoping carrier is a lifting column.

16. The telescoping carrier according to claim 7, wherein the telescoping carrier is a telescoping rail.

17. A hollow profile comprising:
a first individual piece;
a second individual piece;
a third individual piece that is substantially identical to the second individual piece; and
a fourth individual piece that is substantially identical to the first individual piece;
wherein the first individual piece is connected to the second individual piece at a first joining site;
wherein the second individual piece is connected to the fourth individual piece at a second joining site;
wherein the fourth individual piece is connected to the third individual piece at a third joining site; and
wherein the third individual piece is connected to the first individual piece at a fourth joining site.

18. The hollow profile according to claim 17, wherein:
the first individual piece is connected to the second individual piece at the first joining site via a tongue in the first individual piece and a groove in the second individual piece;
the second individual piece is connected to the fourth individual piece at the second joining site via a groove in the second individual piece and a tongue in the fourth individual piece;
the fourth individual piece is connected to the third individual piece at the third joining site via a tongue in the fourth individual piece and a groove in the third individual piece; and
the third individual piece is connected to the first individual piece at the fourth joining site via a groove in the third individual piece and a tongue in the first individual piece.

19. The hollow profile according to claim 18, wherein:
the first individual piece is glued to the second individual piece at the first joining site;
the second individual piece is glued to the fourth individual piece at the second joining site;
the fourth individual piece is glued to the third individual piece at the third joining site; and
the third individual piece is glued to the first individual piece at the fourth joining site.

20. The hollow profile according to claim 17, wherein:
the first individual piece is glued to the second individual piece at the first joining site;
the second individual piece is glued to the fourth individual piece at the second joining site;
the fourth individual piece is glued to the third individual piece at the third joining site; and
the third individual piece is glued to the first individual piece at the fourth joining site.
